(19) United States
(12) Patent Application Publication
(10) Pub. No.: US 2018/0329522 A1
(43) Pub. Date: Nov. 15, 2018

(54) ROTATIONAL APPLICATION DISPLAY FOR MULTI-SCREEN DEVICE

(71) Applicant: Microsoft Technology Licensing, LLC, Redmond, WA (US)

(72) Inventors: Bryant Daniel HAWTHORNE, Duvall, WA (US); Mario Emmanuel MALTEZOS, Redmond, WA (US); Charlene JEUNE, Redmond, WA (US); Matthew JOHNSON, Kirkland, WA (US); John Benjamin HESKETH, Kirkland, WA (US)

(73) Assignee: Microsoft Technology Licensing, LLC, Redmond, WA (US)

(21) Appl. No.: 15/640,291

(22) Filed: Jun. 30, 2017

Related U.S. Application Data
(60) Provisional application No. 62/506,483, filed on May 15, 2017.

(51) Int. Cl. G06F 3/0346; G06F 3/0482; G06F 3/01; G06F 1/16

(52) U.S. Cl. CPC G06F 3/0346; G06F 3/0482; G06F 3/017; G06F 1/1677; G06F 1/1656; G06F 1/1637; G06F 1/1681; G06F 1/1616

(57) ABSTRACT

A mobile computing device including a housing including a first display and a second display mounted to face away from each other, an orientation sensor mounted in the housing, the orientation sensor being configured to detect flip motions indicating that the mobile computing device has been flipped in a direction from a first side to a second side, and a processor mounted in the housing, the processor being configured to display a first application program on the first display, based on detecting a rightward flip motion from the first display to the second display, display a second application program on the second display, and based on detecting a leftward flip motion from the first display to the second display, display a third application program on the second display.

### CROSS REFERENCE TO RELATED APPLICATIONS

This application claims priority to U.S. Provisional Patent Application No. 62/506,483, filed on May 15, 2017, the entirety of which is hereby incorporated herein by reference.

### BACKGROUND

The number of applications and content that users may view on a mobile computing device at a time is limited by the total number of displays that a device contains. Additionally, the smaller display size of mobile computing devices further exacerbates this limitation.

### SUMMARY

To address the above issues, a mobile computing device is provided. The mobile computing device may comprise a housing including a first display and a second display mounted to face away from each other, an orientation sensor mounted in the housing, the orientation sensor being configured to detect flip motions indicating that the mobile computing device has been flipped in a direction from a first side to a second side, and a processor mounted in the housing, the processor being configured to display a first application program on the first display, based on detecting a rightward flip motion from the first display to the second display, display a second application program on the second display, and based on detecting a leftward flip motion from the first display to the second display, display a third application program on the second display.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example mobile computing device of the present description.

FIG. 2A shows an example of two display screens arranged in a side-by-side orientation for the mobile computing device of FIG. 1.

FIG. 2B shows an example of two display screens arranged in a reflex orientation for the mobile computing device of FIG. 1.

FIG. 2C shows an example of two display screens arranged in a back-to-back orientation for the mobile computing device of FIG. 1.

FIG. 2D shows an example of two display screens arranged in a front-to-front orientation for the mobile computing device of FIG. 1.

FIG. 3 shows an example rightward flip motion for the mobile computing device of FIG. 1.

FIG. 4 shows an example leftward flip motion for the mobile computing device of FIG. 1.

FIG. 5 shows an example series of rightward flip motions for the mobile computing device of FIG. 1.

FIG. 6 shows an example series of leftward flip motions for the mobile computing device of FIG. 1.

FIG. 7 shows an example series of rightward and leftward flip motions for the mobile computing device of FIG. 1.

FIG. 8 shows an example backward flip motion for the mobile computing device of FIG. 1.

FIG. 9 shows an example frontward flip motion for the mobile computing device of FIG. 1.

FIG. 10 shows an example method for rotational application display for the example mobile computing device of FIG. 1.

FIG. 11 shows an example computing system according to an embodiment of the present description.

### DETAILED DESCRIPTION

As discussed in detail below, the number of applications and content that users may view at a time is limited by the number of displays that a device contains. If applications are displayed in full-screen, a hinged mobile device having two displays may simultaneously present two applications to the user. However, if the user desires to view a third application, current mobile computing devices may require the user to enter several different inputs to open and close applications before the user may view the third application. The systems and methods described herein have been devised to address these challenges.

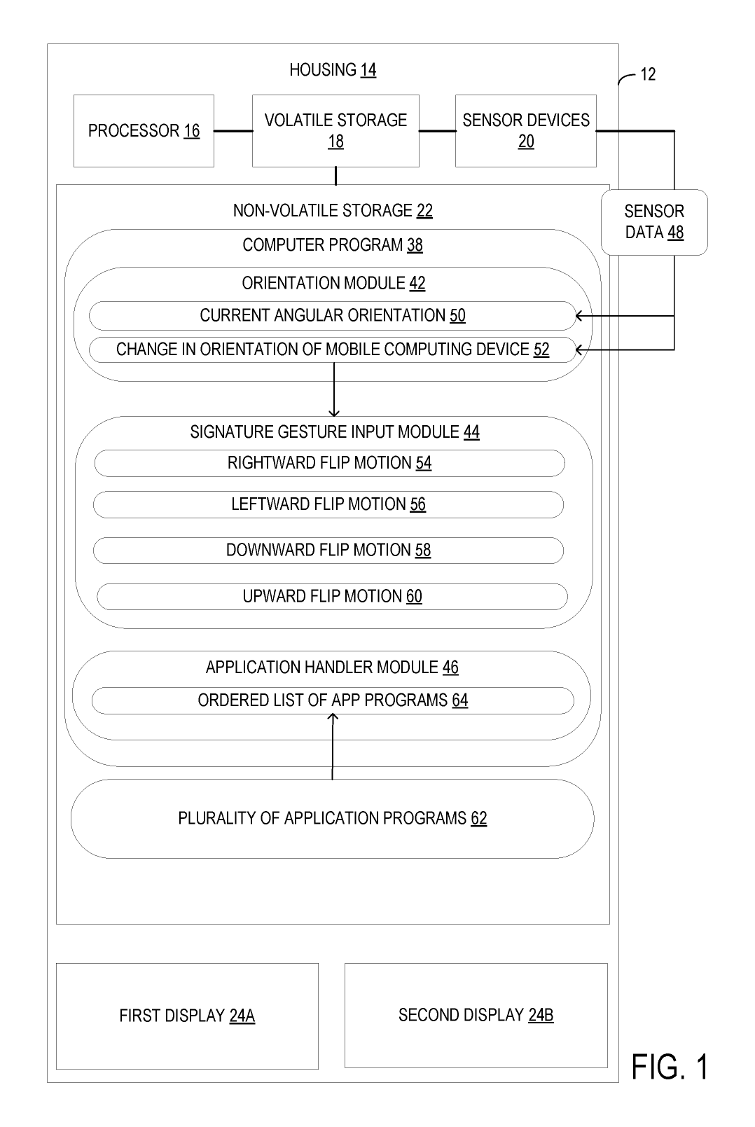

FIG. 1 illustrates a mobile computing device 12 that includes a housing 14, which, for example, may take the form of a casing surrounding internal electronics and providing structure for displays, sensors, speakers, buttons, etc. The housing 14 is configured to include a processor 16, volatile storage device 18, sensor devices 20, non-volatile storage device 22, a first display 24A, and a second display 24B. The first display and second display form a pair of displays 24A and 24B. The sensor devices 20 may include a plurality of different sensors, such as, for example, orientation sensors 25 that may include an inertial measurement unit (IMU) 26, an ambient light sensor 28, a forward facing camera 30, a depth camera 32, etc. The sensor devices 20 may also include a capacitive touch sensor 34, such as a capacitive array that is integrated with both the first display 24A and second display 24B. In another example, the sensor devices 20 may include camera-in-pixel sensors that are integrated with the pair of displays 24A and 24B. It will be appreciated that the examples listed above are exemplary, and that other types of sensors not specifically mentioned above may also be included in the sensor devices 20 of the mobile computing device 12.

The mobile computing device 12 may, for example, take the form of a smart phone device. In another example, the mobile computing device 12 may take other suitable forms, such as a tablet computing device, a wrist mounted computing device, etc.

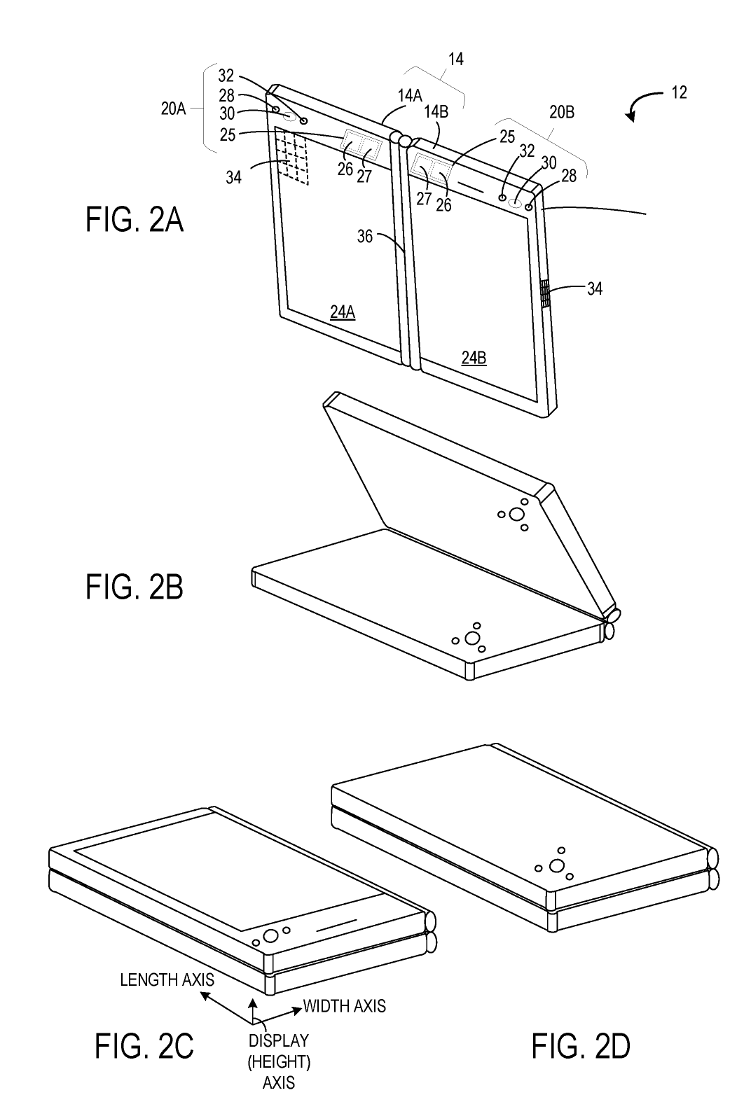

Turning to FIG. 2A, an example mobile computing device 12 is illustrated. As shown, the example mobile computing device 12 includes a housing 14. As discussed above, the housing 14 may be configured to internally house various electronic components of the example mobile computing device 12, including the processor 16, volatile storage device 18, and non-volatile storage device 22. Additionally, the housing 14 may provide structural support for the pair of displays 24A and 24B, and two sensor packages 20A and 20B of the sensor devices 20. In the illustrated example, the sensor devices 20 include one or more orientation sensors 25, which may include one or more spatial sensors 27. The spatial sensors 27 may include, but are not limited to, accelerometers, and/or gyrometers, and/or compasses, and/or magnetometers. In one example, two or more of these components of the spatial sensors 27 may be included in a consolidated package in the form of inertial measurement units 26. In another example, the spatial sensors 27 may further include other types of sensors, such as cameras that may use processing techniques to recognize features of captured images in relation to the environment to determine a spatial orientation of the mobile computing device 12. It will be appreciated that the above examples of orientation sensors 25 are merely exemplary, and that any suitable type of orientation sensor 25 not specifically mentioned above may also be included in the sensor devices 20 to detect a change in spatial orientation of the mobile computing device 12.

The sensor devices 20 may further include forward facing cameras 30. In one example, the forward facing cameras 30 include RGB cameras. However, it will be appreciated that other types of cameras may also be included in the forward facing cameras 30. In this example, forward facing is a direction of the camera's associated display device. Thus, in the example of FIG. 2A, as the screens for the pair of displays 24A and 24B are facing the same direction, both of the forward facing cameras 30 are also facing the same direction. The sensor devices 20 further include an ambient light sensor 28 and a depth camera 32.

As shown, the sensor devices 20 may also include capacitive touch sensors 34 that are integrated with the pair of displays 24A and 24B, as well as other additional displays. In the illustrated embodiment, the capacitive touch sensors 34 include a capacitive grid configured to sense changes in capacitance caused by objects on or near the display devices, such as a user's finger, hand, stylus, etc. In one embodiment, the capacitive touch sensors 34 may also be included on one or more sides of the mobile computing device 12. For example, the capacitive touch sensors 34 may be additionally integrated into the sides of the housing 14 of the mobile computing device 12. While the capacitive touch sensors 34 are illustrated in a capacitive grid configuration, it will be appreciated that other types of capacitive touch sensors and configurations may also be used, such as, for example, a capacitive diamond configuration. In other examples, the sensor devices 20 may include camera-in-pixel devices integrated with each display device including the pair of display 24A and 24B. It will be appreciated that the sensor devices 20 may include other sensors not illustrated in FIG. 2A.

In the example mobile computing device 12 illustrated in FIG. 2A, the two example displays 24A and 24B are movable relative to each other. As shown, the housing 14 has a first part 14A and a second part 14B coupled by a hinge 36, the first part 14A including the first display 24A and the second part 14B including the second display 24B. As illustrated in FIGS. 2A-2D, the hinge 36 is configured to permit the first and second displays 24A and 24B to rotate between angular orientations from a face-to-face angular orientation to a back-to-back angular orientation.

Now turning to FIG. 2B, the hinge 36 permits the pair of displays 24A and 24B to rotate relative to one another such that an angle between the pair of displays 24A and 24B can be decreased or increased by the user applying suitable force to the housing 14 of the mobile computing device 12. As shown in FIG. 2B, the pair of displays 24A and 24B may be rotated until the pair of displays 24A and 24B reach a back-to-back angular orientation, such as the example back-to-back angular orientation shown FIG. 2C.

As illustrated in FIG. 2C, while in an angular orientation where the pair of displays 24A and 24B are in the example back-to-back angular orientation, the pair of displays 24A and 24B face away from each other. Thus, while using the mobile computing device 12, the user may only be able to view one display of the pair of displays 24A and 24B at a time. Additionally, while in a back-to-back angular orientation, sensor packages 20A and 20B of the sensor devices 20, which may each include ambient light sensors 28, forward facing cameras 30, and depth cameras 32, also face in the same direction as their respective display, and thus also face away from each other.

As shown in FIG. 2D, the angular orientation between the pair of displays 24A and 24B may also rotate to a face-to-face orientation where the pair of display 24A and 24B face each other. Such an angular orientation may help protect the screens of the display devices.

In one implementation, the face-to-face angular orientation is defined to have an angular displacement as measured from display to display of between 0-90 degrees, an open angular orientation is defined to be between 90-270 degrees, and a back-to-back orientation is defined to be from 270-360 degrees. Alternatively, an implementation in which the open orientation is not used to trigger behavior may be provided, and in this implementation, the face-to-face angular orientation may be defined to be between 0 and 180 degrees and the back-to-back angular orientation may be defined to be between 180 and 360 degrees. In either of these implementations, when tighter ranges are desired, the face-to-face angular orientation may be defined to be between 0 and 60 degrees, or more narrowly to be between 0 and 30 degrees, and the back-to-back angular orientation may be defined to be between 300-360 degrees, or more narrowly to be 330-360 degrees. The zero degree position may be referred to as fully closed in the fully face-to-face angular orientation and the 360 degree position may be referred to as fully open in the back-to-back angular orientation. In implementations that do not use a double hinge and which are not able to rotate a full 360 degrees, fully open and/or fully closed may be greater than zero degrees and less than 360 degrees.

Turning back to FIG. 1, the processor 16 is configured to execute a computer program 38, which, for example, may be an operating system or control program for the mobile computing device 12, and a plurality of application programs 40 stored on the non-volatile storage device 22, and to enact various control processes described herein. In some examples, the processor 16, volatile storage device 18, and non-volatile storage device 22 are included in a System-On-Chip configuration.

The computer program 38 executed by the processor 16 includes an orientation module 42, a signature gesture input module 44, and an application handler module 46. As shown in FIG. 1, the orientation module 42 is configured to receive sensor data 48 from the sensor devices 20. For example, the sensor data 48 may include data from the one or more orientation sensors 25 that may include one or more IMUs 26 of the mobile computing device 12, which, for example, may be configured to provide position and/or orientation data of the mobile computing device 12. In one implementation, the one or more IMUs 26 may be configured as a six-axis or six-degree of freedom (6DOF) position sensor system. Such a configuration may include three accelerometers and three gyroscopes to indicate or measure a change in location of the mobile computing device 12 along three orthogonal spatial axes (e.g., x, y, and z) and a change in device orientation about three orthogonal rotation axes (e.g., yaw, pitch, and roll). In some implementations, position and orientation data from the forward facing cameras 30 and the IMU 26 may be used in conjunction to determine a position and orientation (or 6DOF pose) of the mobile computing device 12.

Based on the sensor data 48, the orientation module 42 is configured to detect a current angular orientation 50 between the pair of displays 24A and 24B indicating that the pair of display devices 24A and 24B are facing away from each other. As discussed previously, the angular orientation between the pair of displays 24A and 24B may rotate through angular orientations between a face-to-face angular orientation to a back-to-back angular orientation. Thus, the orientation module 42 of the computer program 38 executed by the processor 16 is configured to detect a current angular orientation 50 indicating that the first and second displays 24A and 24B are facing away from each other, such as a back-to-back angular orientation.

The orientation module 42 may be configured to detect the current angular orientation 50 based on different types of sensor data. In one example, the current angular orientation 50 may be detected based on sensor data 48 from the one or more orientation sensors 25, such as, for example, the IMUs 26. As the user applies force to the housing 14 of the mobile computing device 12 to rotate the pair of displays 24A and 24B, the one or more IMUs 26 will detect the resulting movement. Thus, based on IMU data for a new rotation and a previously known angular orientation between the pair of the displays 24A and 24B, the orientation module 42 may calculate a new current angular orientation 50 resulting after the user rotates the pair of displays 24A and 24B. In addition, the IMU data may be used to compute an angular orientation of the hinge (i.e., face-to-face relative angular displacement of the first and second displays) However, it will be appreciated that the current angular orientation 50 may also be calculated via other suitable methods. For example, the sensor devices 20 may further include a hinge sensor in the hinge 36 that is configured to detect an angular orientation of the hinge 36, and thereby detect a current angular orientation of the pair of displays 24A and 24B.

The orientation module 42 of the computer program 38 executed by the processor 16 is further configured to detect a change in orientation 52 of the mobile computing device 12 based on the sensor data 48 received via sensor devices 20. For example, the orientation module 42 may detect and calculate changes in orientation of the mobile computing device 12 based on spatial orientation data received via the one or more orientation sensors 25, which, for example, may include one or more IMUs 26. The changes in orientation 52 detected by the orientation module 42 include rotations around each of the rotation axes, such as, for example, six-axis or 6DOF. Additionally, as shown in FIG. 1, the changes in orientation 52 of the mobile computing device 12 are sent to the signature gesture input module 44.

The signature gesture input module 44 is configured to determine whether any changes in orientation of the mobile computing device 12 match predetermined signature gesture inputs. For example, the signature gesture inputs include a flip motion input, which is a change in orientation that causes the mobile computing device 12 to be flipped or substantially flipped to the other side, thus resulting in a change in which display device of the pair of display devices 24A and 24B is being viewed by the user. In one example, the signature gesture input module 44 is configured to detect a rightward flip motion 54, a leftward flip motion 56, a downward flip motion 58, and an upward flip motion 60. Thus, the signature gesture input module 44 of the computing program 38 executed by the processor 16 is configured to detect a signature gesture input, including rightward flip motions 54, leftward flip motions 56, downward flip motions 58, and upward flip motions 60 based on sensor data 48 received via the orientation sensors 25, which may include IMUs 26, indicating that the mobile computing device 12 has been rotated in a direction (e.g. rightward, leftward, upward, downward) more than a threshold degree. In one example, the threshold degree is set at 120 degrees. Thus, if the change in orientation 52 of the mobile computing device 12 determined by the orientation module 42 is greater than 120 degrees, the signature gesture input module 44 detects the corresponding flip motion input. However, it will be appreciated that other threshold degrees may be set depending upon a desired sensitivity, such as, for example, 90 degrees, 100 degrees, or 180 degrees. The flip motion could be measured from the beginning of the motion, based on accelerometer data. Typically, the flip motion occurs around a width or length axis of the computing device, and not around a display axis, when hinge of the device is fully open and back-to-back orientation, as shown in FIG. 2C.

As illustrated in FIG. 1, the processor 16 is further configured to execute a plurality of application programs 62 stored on non-volatile storage 22. In one example, the plurality of application programs 62 may include application programs associated with the computer program 38, and/or an operating system of the mobile computing device 12. In another example, the plurality of application programs 62 may further include 3rd party applications that were downloaded via other means, such as, for example, an application store.

As shown, the application handler module 46 of the computer program 38 is configured to determine an ordered list of application programs 64, which is an ordered list of the plurality of application programs 62. The ordered list of application programs 64 may, for example, take the form of a linked list, array, or any other suitable ordered list data structure. Application programs from the plurality of application programs 62 may be ordered in the ordered list of application programs 64 based on, for example, when each application program was last opened or executed by the user. That is, application programs that have most recently been opened may be placed higher in the ordered list of application programs 64, while application programs that have less recently been opened may be placed lower in the ordered list of application programs 64. As another example, application programs in the ordered list of application programs 64 may be ordered based on adjustable settings. It will be appreciated that the above example methods of ordering application programs in the ordered list of application programs 64 are exemplary, and that any suitable ordering method may be used by the application handler module 46 to determine the ordered list of application programs 64.

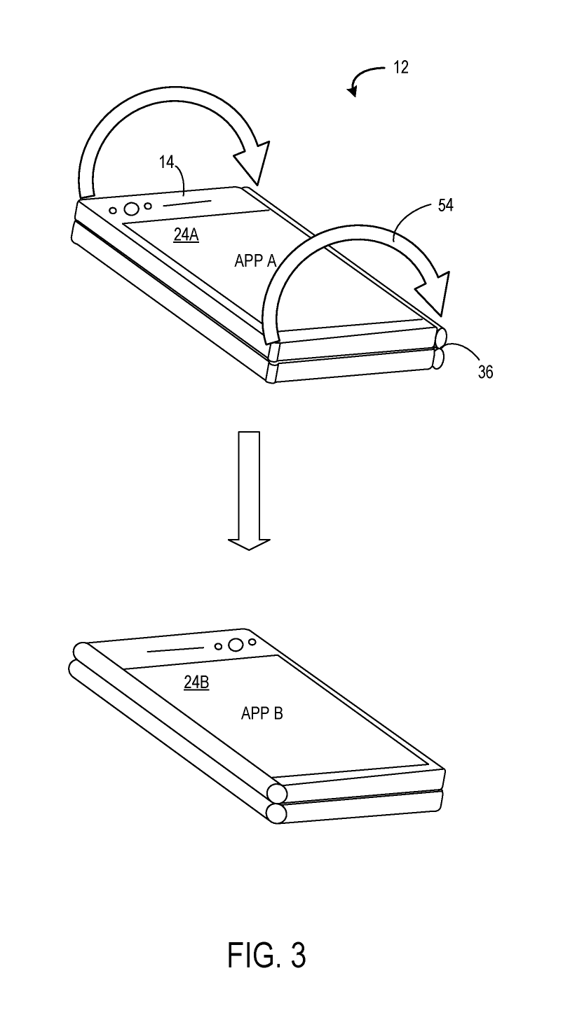

Now turning to FIG. 3, the housing 14 of the mobile computing device 12 includes the first display 24A and the second display 24B that face away from each other. In the illustrated example, the housing includes the hinge 36, and first display 24A and the second display 24B are in a back-to-back angular orientation, and thus face away from each other. In another example, the mobile computing device 12 may not include a hinge 36, and the first and second displays 24A and 24B may be mounted on both sides of the housing 14 such that they face away from each other.

As discussed previously, the one or more orientation sensors 25, which may include IMUs 26, mounted in the housing 14 are configured to detect flip motions indicating that the mobile computing device 12 has been flipped in a direction from a first side, such as first part 14A of the housing 14, to a second side, such as the second side 14B of the housing 14. By flipping the mobile computing device 12 to another side, the user changes which display of the pair of displays 24A and 24B is being viewed. Thus, if different application programs of the plurality of application programs 62 are displayed on the pair of display 24A and 24B, the user may view the different application programs by flipping the mobile computing device 12 to view the other display of the pair of displays 24A and 24B.

In the illustrated example, the processor 16 mounted in the housing 14 is configured to display a first application program (APP A) on the first display 24A. The first application program APP A may be selected from the ordered list of application programs 64, or may be an application program selected by the user via a user input from the plurality of application programs 62. Next, the user flips the mobile computing device 12 in a rightward direction from the first display 24A to the second display 24B. The flip motion is detected by the one or more orientation sensors 25, which may include IMUs 26, of the mobile computing device 12, and sent to the computer program 38 as sensor data 48. The signature gesture input module 44 detects that the flip motion is a rotation greater than a threshold value and in a rightward direction, and thus detects a rightward flip motion 54. Based on detecting the rightward flip motion 54 from the first display 24A to the second display 24B, the processor 16 is further configured to display a second application program (APP B) on the second display 24B.

However, if the user flips the mobile computing device 12 in a different direction, it will be appreciated that the mobile computing device 12 may still be flipped from the first display 24A to the second display 24B. The flip motion in the different direction may be detected and differentiated from the rightward flip motion 54 by the signature gesture input module 44. Based on detecting the flip motion, the processor 16 may display a different application program on the second display 24B than was displayed based on detecting the rightward flip motion 54. In this manner, the mobile computing device 12 may display different application programs on the pair of display devices 24A and 24B based on which directions the user flips the mobile computing device 12.

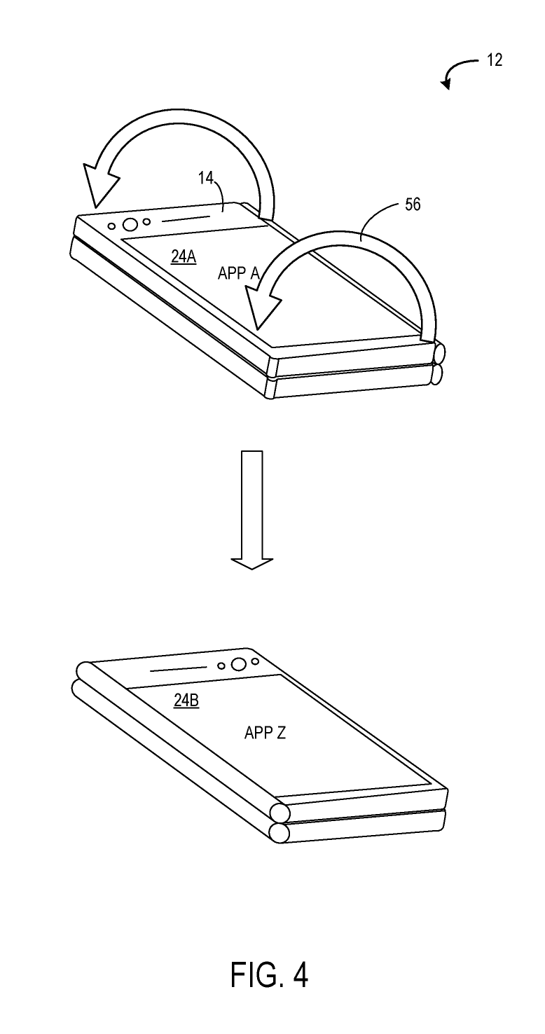

For example, FIG. 4 illustrates a leftward flip motion 56. As shown, the user flips the mobile computing device 12 in a leftward direction from the first display 24A to the second display 24B. The signature gesture input module 44 detects the flip motion as a leftward flip motion 56 that is different than the rightward flip motion 54. In this example, the processor 16 of the mobile computing device 12 is configured to, based on detecting a leftward flip motion 56 from the first display 24A to the second display 24B, display a third application program (APP Z) on the second display 24B. It will be appreciated that both the leftward flip motion 56 and the rightward flip motion 54 resulted in the mobile computing device being flipped from one display to the other of the pair of displays 24A and 24B. However, based on the specific direction of the flip motion, the processor 16 is configured to execute and display a different application program of the plurality of application programs 62 on the display that was flipped to via the flip motion. In the specific example of FIGS. 3 and 4, the processor is configured to display a second application program APP B based on detecting a rightward flip motion 54, and a third application program APP Z different from the second application program APP B based on detecting a leftward flip motion 56. In this manner, the mobile computing device 12 allows the user to easily switch between views of a larger number of application programs than a number of displays of the mobile computing device 12.

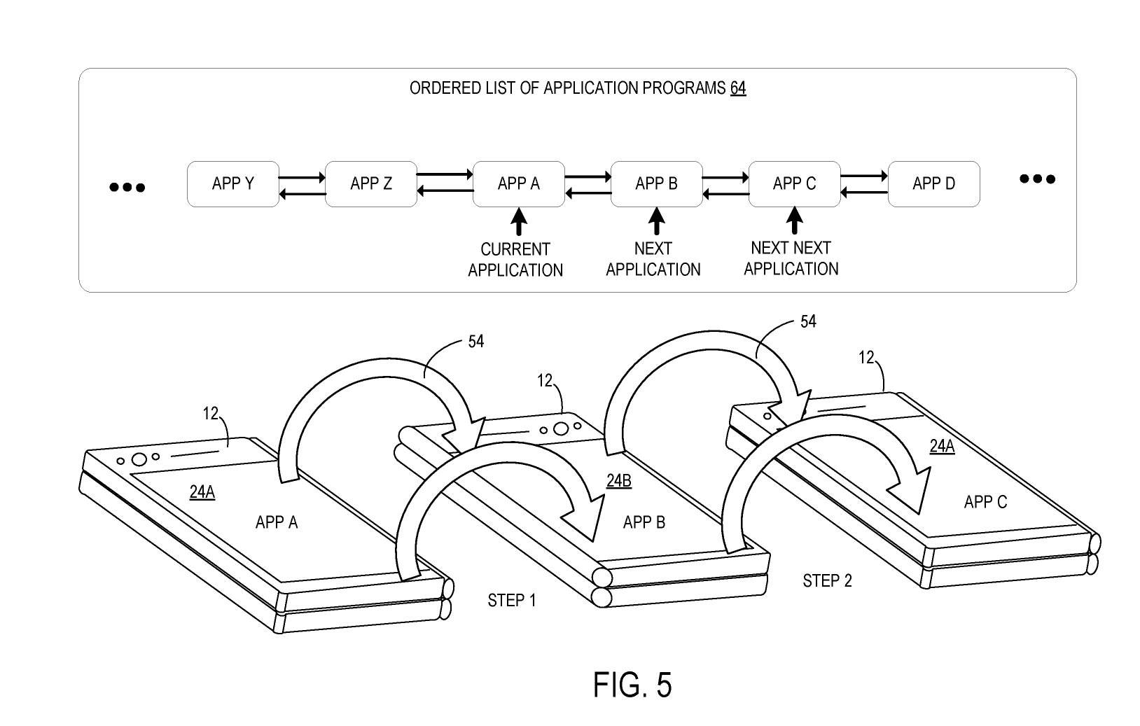

FIG. 5 illustrates an example of sequential rightward flip motions. As discussed previously, the application handler module 46 determines an ordered list of application programs 64 for the plurality of application programs 62 stored on the mobile computing device 12. In the illustrated example, the first application program APP A is a current application program in the ordered list of application programs 64 and the second application program APP B is a next application program in the ordered list of application programs 64. In this example, the current application program is the application program that is currently being displayed on the specific display being viewed by the user of the mobile computing device 12, and the next application program is the application program that will be displayed on the display that is flipped to via a rightward flip motion 54.

As shown in FIG. 5, at step 1, the user flips the mobile computing device 12 with a rightward flip motion 54 from the first display 24A to the second display 24B. Thus, based on detecting the rightward flip motion 54 at step 1, the processor 16 displays the next application program in the ordered list of application programs 64, which is the second application APP B in this example, on the second display 24B that was just flipped to via the rightward flip motion 54. It will be appreciated that after the rightward flip motion 54 at step 1, the user is now viewing the second application program APP B on the second display 24B. Thus, the second application program APP B is now the current application program, and application program APP C is the next application program of the second application program APP B. The application program APP C may also be considered as the next next application program of the first application program APP A. These relationships between the application programs in the ordered list of application programs 64 may be determined by the application handler module 46.

At step 2, the user flips the mobile computing device 12 with another rightward flip motion 54, this time flipping the mobile computing device 12 from the second display 24B to the first display 24A. Based on detecting the another rightward flip motion, the processor 16 is configured to display the next next application program APP C on the first display 24A that was flipped to via the another rightward flip motion. Thus, it will be appreciated that although the user is now viewing the first display 24A once again, a different application program is displayed on the first display 24A. Rather than the first application program APP A, the next next application program APP C is displayed on the first display 24A. In this manner, the processor 16 is configured to, for each subsequent rightward flip motion 54, display corresponding next application programs in the ordered list of application programs 64. That is, for each subsequent rightward flip motion 54, the processor 16 is configured to display the corresponding next application program in the ordered list of application programs 64 on the display that is being flipped to via that rightward flip motion 54. It will be appreciated that while only two rightward flip motions and three corresponding application programs are shown in the illustrated example, that any number of sequential rightward flip motions may be detected for up to N application programs. Additionally, in only example, the ordered list of application programs 64 may include a loop, such that continuous sequential rightward flip motions will continue to cycle through the ordered list of application programs 64.

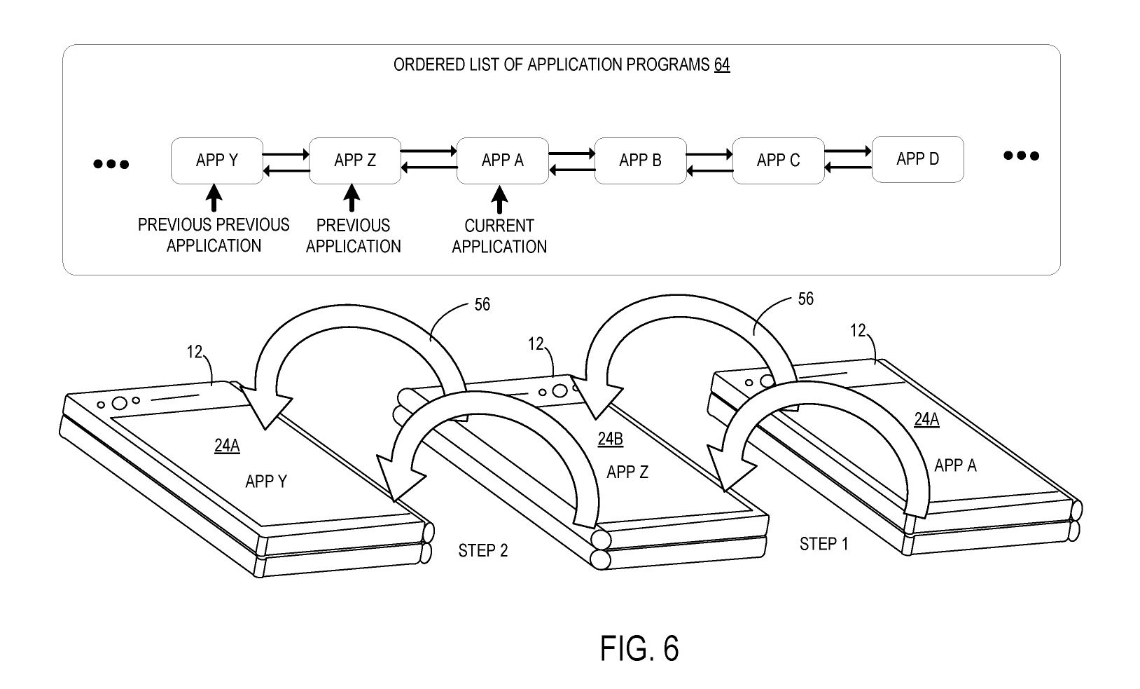

FIG. 6 illustrates an example of sequential leftward flip motions. As discussed previously, the application handler module 46 determines an ordered list of application programs 64 for the plurality of application programs 62 stored on the mobile computing device 12. In the illustrated example, the first application program APP A is a current application program in the ordered list of application programs 64 and the third application program APP Z is a previous application program in the ordered list of application programs 64. In this example, the previous application program is the application program that will be displayed on the display that is flipped to via a leftward flip motion 56.

As shown in FIG. 6, at step 1, the user flips the mobile computing device 12 with a leftward flip motion 56 from the first display 24A to the second display 24B. Thus, based on detecting the leftward flip motion 56 at step 1, the processor 16 displays the previous application program in the ordered list of application programs 64, which is the third application APP Z in this example, on the second display 24B that was just flipped to via the leftward flip motion 56. It will be appreciated that after the leftward flip motion 56 at step 1, the user is now viewing the third application program APP Z on the second display 24B. Thus, the third application program APP Z is now the current application program, and application program APP Y is the previous application program of the third application program APP Z. The application program APP Y may also be considered as the previous previous application program of the first application program APP A. These relationships between the application programs in the ordered list of application programs 64 may be determined by the application handler module 46.

At step 2, the user flips the mobile computing device 12 with another leftward flip motion 56, this time flipping the mobile computing device 12 from the second display 24B to the first display 24A. Based on detecting the another leftward flip motion, the processor 16 is configured to display the previous previous application program APP Y on the first display 24A that was flipped to via the another leftward flip motion. Thus, it will be appreciated that although the user is now viewing the first display 24A once again, a different application program is displayed on the first display 24A. Rather than the first application program APP A, the previous previous application program APP Y is displayed on the first display 24A. In this manner, the processor 16 is configured to, for each subsequent leftward flip motion, display corresponding previous application programs in the ordered list of application programs 64. That is, for each subsequent leftward flip motion 56, the processor 16 is configured to display the corresponding previous application program in the ordered list of application programs 64 on the display that is being flipped to via that leftward flip motion 56. It will be appreciated that while only two leftward flip motions and three corresponding application programs are shown in the illustrated example, that any number of sequential leftward flip motions may be detected for up to N application programs. Additionally, in the example where the ordered list of application programs 64 includes a loop, continuous sequential leftward flip motions will also continue to cycle through the ordered list of application programs 64.

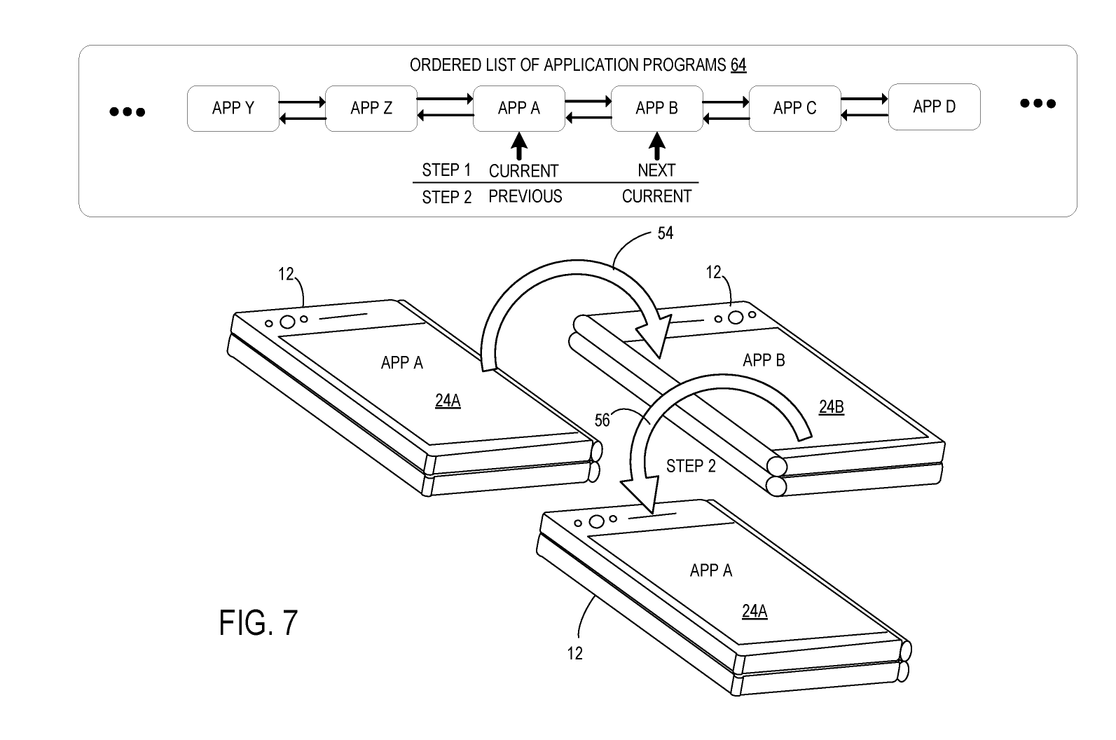

Now turning to FIG. 7, the user may sequentially flip the mobile computing device 12 with a mix of different flip motions. In the illustrated example, at step 1, the user flips the mobile computing device 12 with a rightward flip motion 54 from the first display 24A to the second display 24B. As discussed previously, the processor 16 displays the next application, which is the second application APP B in this example, on the second display 24B that was flipped to via the rightward flip motion 54. Thus, as the second application APP B is now being displayed on the currently viewed display that is the second display 24B, the second application APP B becomes the current application program. Accordingly, as the second application APP B is the current application program, the first application program APP A becomes the previous application program in the ordered list of application programs 64.

At step 2, the user sequentially flips the mobile computing device 12 with a leftward flip motion 56 from the second display 24B to the first display 24A. Thus, the processor 16 displays the previous application, which is now the first application APP A in this example, on the first display 24A that was flipped back to via the sequential leftward flip motion 56. In this manner, the rightward flip motion 54 at step 1 was cancelled out by the sequential leftward flip motion 56 at step 2, and the first application APP A is displayed once again on the first display 24A. According to the methods discussed above, the user may cycle back and forth through the ordered list of application programs 64 via sequential rightward and leftward flip motions. It will be appreciated that the examples of flip motions discussed above, including rightward and leftward flip motions, are exemplary, and that other types of flip motions not specifically mentioned above may also be detected and used to select which application program of the plurality of application programs 62 will be displayed.

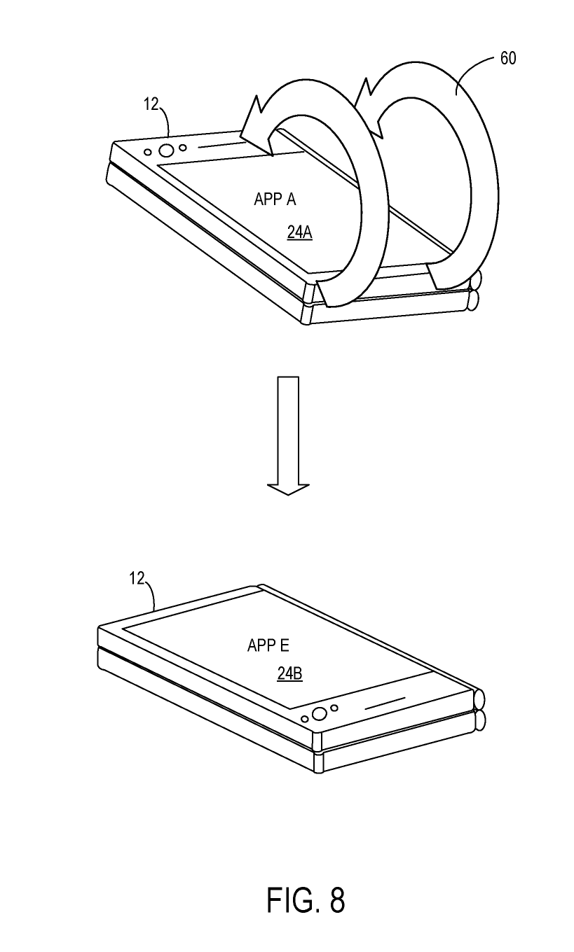

For example, FIG. 8 illustrates an upward flip motion 60. As shown, the user flips the mobile computing device 12 in an upward direction from the first display 24A to the second display 24B. The signature gesture input module 44 detects the flip motion as an upward flip motion 60. In this example, the processor 16 of the mobile computing device 12 is configured to, based on detecting the frontward flip motion 60 from the first display 24A to the second display 24B, display a fourth application (APP E) on the second display 24B. Similarly to the leftward and rightward flip motions, the upward flip motion also results in the mobile computing device being flipped from one display to the other of the pair of displays 24A and 24B. However, based on the specific upward direction of the upward flip motion 60, the processor 16 is configured to execute and display a different application program of the plurality of application programs 62 than would be displayed based on a leftward or rightward flip motion.

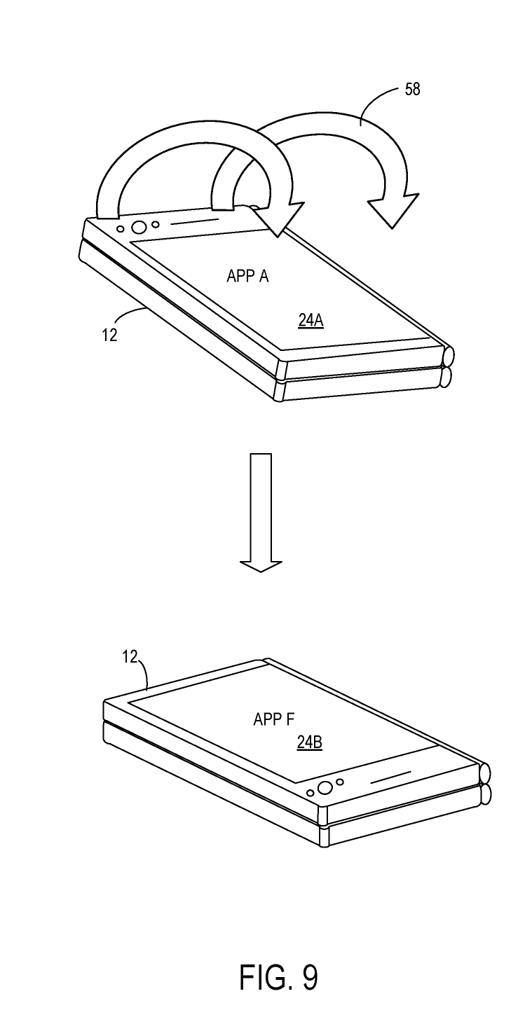

As another example, FIG. 9 illustrates a downward flip motion 58. As shown, the user flips the mobile computing device 12 in a downward direction from the first display 24A to the second display 24B. The signature gesture input module 44 detects the flip motion as a downward flip motion 58. In this example, the processor 16 of the mobile computing device 12 is configured to, based on detecting the downward flip motion from the first display 24A to the second display 24B, display a fifth application (APP F) on the second display 24B. As with the leftward, rightward, and upward flip motions, the downward flip motion also results in the mobile computing device being flipped from one display to the other of the pair of displays 24A and 24B. However, based on the specific downward direction of the downward flip motion 60, the processor 16 is configured to execute and display a different application program of the plurality of application programs 62 than would be displayed based on a leftward, rightward, or upward flip motion. It should be understood that typically these motions (leftward, rightward, upward, and downward flip motions) are defined in device space, i.e., a frame of reference fixed relative to the mobile computing device 12, as shown in FIG. 2C.

It will be appreciated that the terms “first”, “second”, “third”, “fourth”, and “fifth”, for the first application program, second application program, third application program, fourth application program, and fifth application program, are merely used for naming purposes to differentiate the plurality of different application programs, and are not meant to denote a specific ordering of application programs. That is, the first through fifth application programs may, for example, not be associated in a particular order or queue. Additionally, in examples where the first through fifth application programs are included in the ordered list of application programs 64, the first through fifth application programs may be ordered in any suitable order.

Additionally, it will be understood that when one of the above application programs is displayed on the first or second display of the mobile computing device 12, that application program may also utilize other hardware resources associated with that display, such as, for example, the associated forward facing camera, an associated speaker, an associated microphone, associated capacitive touch sensors, and other hardware resources associated with that display.

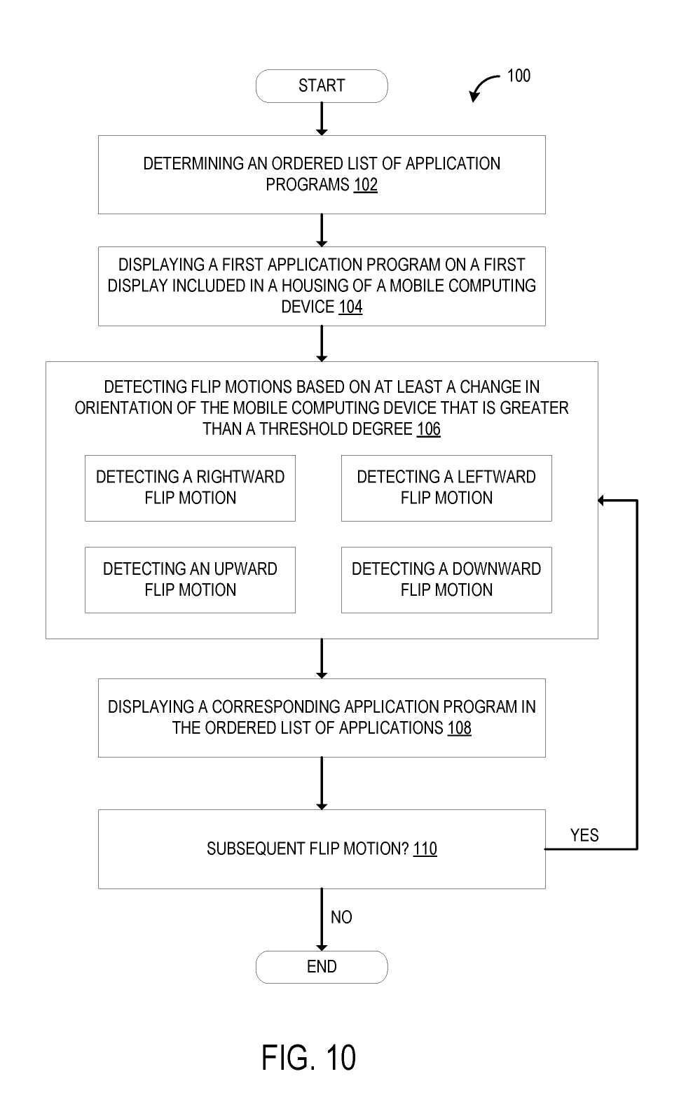

FIG. 10 shows an example computer-implemented method 100 for rotational application display for a multi-screen mobile computing device. At step 102, the method 100 may include determining an ordered list of application programs, wherein a first application program is a current application program in the ordered list of application programs, a second application program is a next application program in the ordered list of application programs, and a third application program is a previous application program in the ordered list of application programs. The ordered list of application programs 64 may, for example, take the form of a linked list, array, or any other suitable ordered list data structure. Application programs from the plurality of application programs 62 may be ordered in the ordered list of application programs 64 based on, for example, when each application program was last opened or executed by the user. That is, application programs that have most recently been opened may be placed higher in the ordered list of application programs 64, while application programs that have less recently been opened may be placed lower in the ordered list of application programs 64. As another example, application programs in the ordered list of application programs 64 may be ordered based on adjustable settings.

At step 104, the method 100 may include displaying a first application program on a first display included in a housing of a mobile computing device, the housing further including a second display facing away from the first display, and an orientation sensor configured to detect flip motions indicating that the mobile computing device has been flipped in a direction from a first side to a second side. In one example, the first application program displayed on the first display may be the current application program in the ordered list of application programs 64. In one example, the housing of the mobile computing device may have a first part and a second part coupled by a hinge, the first part including the first display and the second part including the second display, wherein the hinge is configured to permit the first and second displays to rotate between angular orientations from a face-to-face angular orientation to a back-to-back angular orientation, and the processor may be further configured to detect that the first and second displays are in a back-to-back angular orientation. Thus, in this example, if the user is currently viewing the first display, in order to view the second display, the user may flip the mobile computing device in a direction, such as leftward, rightward, upward, or downward, from the first side to the second side.

At step 106, the method 100 may include detecting flip motions based on at least a change in orientation of the mobile computing device that is greater than a threshold degree detected via the orientation sensor. In one example, the processor is configured to detect a rightward flip motion 54, a leftward flip motion 56, a downward flip motion 58, and an upward flip motion 60, based on sensor data 48 received via the orientation sensors 25, such as IMUs 26, indicating that the mobile computing device 12 has been rotated in a direction (e.g. rightward, leftward, upward, downward) more than a threshold degree. In one example, the threshold degree is set at 120 degrees. Thus, if the change in orientation 52 of the mobile computing device 12 determined by the orientation module 42 is greater than 120 degrees, the signature gesture input module 44 detects the corresponding flip motion input. However, it will be appreciated that other threshold degrees may be set depending upon a desired sensitivity, such as, for example, 90 degrees, 100 degrees, or 180 degrees. The flip motion could be measured from the beginning of the motion, based on accelerometer data. Typically, the flip motion occurs around a width or length axis of the computing device, and not around a display axis, when hinge of the device is fully open and back-to-back orientation.

At step 110, the method 100 may include displaying a corresponding application program in the ordered list of application programs based on the type of detect flip motion, such as a rightward flip motion, leftward flip motion, upward flip motion, or downward flip motion. In one example, based on detecting a rightward flip motion from the first display to the second display, step 110 includes displaying a second application program on the second display, such as the next application program in the ordered list of application programs. Additionally, based on detecting a leftward flip motion from the first display to the second display, step 110 includes displaying a third application program on the second display, such as the previous application program in the ordered list of application programs. Thus, depending upon which direction (e.g. rightward or leftward) the user flips the mobile computing device, a different application program will be displayed on the same second display that is flipped to in both scenarios.

In another example, based on detecting an upward flip motion from the first display to the second display, step 110 includes displaying a fourth application program on the second display. In another example, based on detecting a downward flip motion from the first display to the second display, step 110 includes displaying a fifth application program on the second display. As discussed previously, the particular application program to be displayed based on the determined direction of the flip motion may be set automatically or may be a setting adjusted by the user. For example, the user may select particular application programs that will be displayed via an upward flip motion and a downward flip motion.

At step 118, the method 100 may include detecting a subsequent flip motion. For example, after flipping the mobile computing device from the first display to the second display via a rightward flip motion, the user may subsequently flip the mobile computing device from the second display back to the first display via a subsequent rightward flip motion, and a new application program may be displayed on the first display different from the first application program. On the other hand, the user may instead subsequently flip the mobile computing device from the second display back to the first display via a subsequent leftward flip motion, and the first application program may be displayed on the first display once again.

Thus, if a subsequent flip motion is detected at step 110, the method 100 may loop back to step 106 including detecting the subsequent flip motion based on at least a change in orientation of the mobile computing device that is greater than the threshold degree. Additionally, in one example, for each subsequent rightward flip motion, the method 100 may include, at the current iteration of step 108, displaying corresponding next application programs in the ordered list of application programs. On the other hand, in this example, for each subsequent leftward flip motion, the method 100 may include, at the current iteration of step 108, displaying corresponding previous application programs in the ordered list of application programs. For each subsequent flip motion detected at step 110, the method 100 may loop back to step 106. On the other hand, if not subsequent flip motion is detected at step 110, the method 100 may end.

In some embodiments, the methods and processes described herein may be tied to a computing system of one or more computing devices. In particular, such methods and processes may be implemented as a computer-application program or service, an application-programming interface (API), a library, and/or other computer-program product.

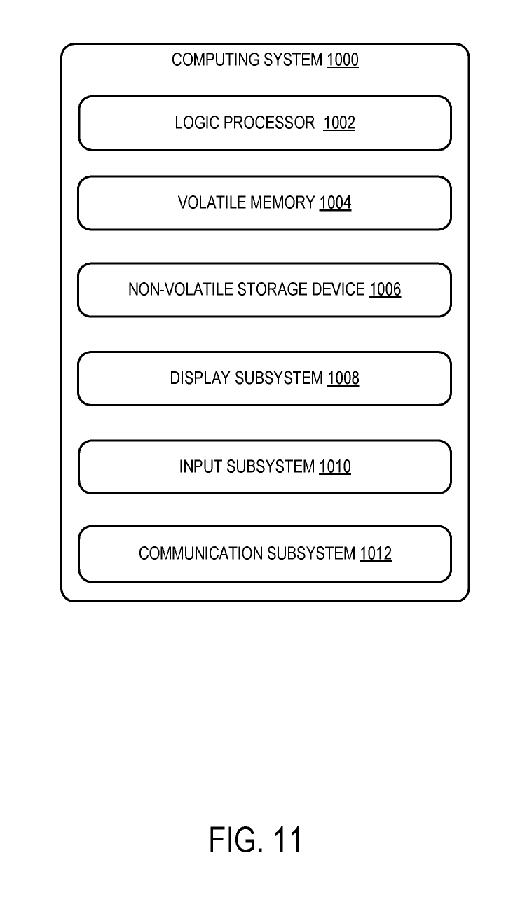

FIG. 11 schematically shows a non-limiting embodiment of a computing system 1000 that can enact one or more of the methods and processes described above. Computing system 1000 is shown in simplified form. Computing system 1000 may embody the mobile computing device 12 described above. Computing system 1000 may take the form of one or more tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 1000 includes a logic processor 1002 volatile memory 1004, and a non-volatile storage device 1006. Computing system 1000 may optionally include a display subsystem 1008, input subsystem 1010, communication subsystem 1012, and/or other components not shown in FIG. 11.

Logic processor 1002 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 1002 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 1006 includes one or more physical devices configured to hold instructions executable by the logic processors to implement the methods and processes described herein. When such methods and processes are implemented, the state of non-volatile storage device 1004 may be transformed—e.g., to hold different data.

Non-volatile storage device 1006 may include physical devices that are removable and/or built-in. Non-volatile storage device 1006 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 1006 may include nonvolatile, dynamic, static, read/write, read-only, sequential-access, location-addressable, file-addressable, and/or content-addressable devices. It will be appreciated that non-volatile storage device 1006 is configured to hold instructions even when power is cut to the non-volatile storage device 1006.

Volatile memory 1004 may include physical devices that include random access memory. Volatile memory 1004 is typically utilized by logic processor 1002 to temporarily store information during processing of software instructions. It will be appreciated that volatile memory 1004 typically does not continue to store instructions when power is cut to the volatile memory 1004.

Aspects of logic processor 1002, volatile memory 1004, and non-volatile storage device 1006 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 typically implemented in software by a processor to perform a particular function using portions of volatile memory, which function involves transformative processing that specially configures the processor to perform the function. Thus, a module, program, or engine may be instantiated via logic processor 1002 executing instructions held by non-volatile storage device 1006, using portions of volatile memory 1004. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 1008 may be used to present a visual representation of data held by non-volatile storage device 1006. The display subsystem 1008 may embody the first display 24A and the second display 24B of the mobile computing device 12. The visual representation may take the form of a graphical user interface (GUI). As the herein described methods and processes change the data held by the non-volatile storage device, and thus transform the state of the non-volatile storage device, the state of display subsystem 1008 may likewise be transformed to visually represent changes in the underlying data. Display subsystem 1008 may include one or more display devices utilizing virtually any type of technology. Such display devices may be combined with logic processor 1002, volatile memory 1004, and/or non-volatile storage device 1006 in a shared enclosure, or such display devices may be peripheral display devices.

When included, input subsystem 1010 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1012 may be configured to communicatively couple various computing devices described herein with each other, and with other devices. Communication subsystem 1012 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 1000 to send and/or receive messages to and/or from other devices via a network such as the Internet.

The following paragraph provides additional support for the claims of the subject application. One aspect provides a mobile computing device comprising a housing including a first display and a second display that face away from each other, an orientation sensor mounted in the housing, the orientation sensor being configured to detect flip motions indicating that the mobile computing device has been flipped in a direction from a first side to a second side and a processor mounted in the housing, the processor being configured to display a first application program on the first display, based on detecting a rightward flip motion from the first display to the second display, display a second application program on the second display, and based on detecting a leftward flip motion from the first display to the second display, display a third application program on the second display. In this aspect, additionally or alternatively, the orientation sensor may be an inertial measurement unit. In this aspect, additionally or alternatively, the processor may be configured to detect flip motions based on at least a change in orientation of the mobile computing device that is greater than a threshold degree detected via the inertial measurement unit. In this aspect, additionally or alternatively, the processor may be further configured to determine an ordered list of application programs, and wherein the first application program may be a current application program in the ordered list of application programs, the second application program may be a next application program in the ordered list of application programs, and the third application program may be a previous application program in the ordered list of application programs. In this aspect, additionally or alternatively, the processor may be further configured to, for each subsequent rightward flip motion, display corresponding next application programs in the ordered list of application programs. In this aspect, additionally or alternatively, the processor may be further configured to, for each subsequent leftward flip motion, display corresponding previous application programs in the ordered list of application programs. In this aspect, additionally or alternatively, the processor may be further configured to, based on detecting an upward flip motion from the first display to the second display, display a fourth application program on the second display. In this aspect, additionally or alternatively, the processor may be further configured to, based on detecting a downward flip motion from the first display to the second display, display a fifth application program on the second display. In this aspect, additionally or alternatively, the housing may have a first part and a second part coupled by a hinge, the first part including the first display and the second part including the second display, wherein the hinge may be configured to permit the first and second displays to rotate between angular orientations from a face-to-face angular orientation to a back-to-back angular orientation, and wherein the processor may be further configured to detect that the first and second displays are in a back-to-back angular orientation.

Another aspect provides a method comprising displaying a first application program on a first display included in a housing of a mobile computing device, the housing further including a second display facing away from the first display, and an orientation sensor configured to detect flip motions indicating that the mobile computing device has been flipped in a direction from a first side to a second side, based on detecting a rightward flip motion from the first display to the second display, displaying a second application program on the second display, and based on detecting a leftward flip motion from the first display to the second display, displaying a third application program on the second display. In this aspect, additionally or alternatively, the method may include detecting flip motions based on at least a change in orientation of the mobile computing device that is greater than a threshold degree detected via the orientation sensor. In this aspect, additionally or alternatively, the threshold degree may be 90 degrees. In this aspect, additionally or alternatively, the method may include determining an ordered list of application programs, wherein the first application program may be a current application program in the ordered list of application programs, the second application program may be a next application program in the ordered list of application programs, and the third application program may be a previous application program in the ordered list of application programs. In this aspect, additionally or alternatively, the method may include, for each subsequent rightward flip motion, displaying corresponding next application programs in the ordered list of application programs. In this aspect, additionally or alternatively, the method may include, for each subsequent leftward flip motion, displaying corresponding previous application programs in the ordered list of application programs. In this aspect, additionally or alternatively, the method may include, based on detecting an upward flip motion from the first display to the second display, displaying a fourth application program on the second display. In this aspect, additionally or alternatively, the method may include, based on detecting a downward flip motion from the first display to the second display, displaying a fifth application program on the second display.

Another aspect provides a mobile computing device comprising a housing including a first display and a second display that face away from each other, an inertial measurement unit mounted in the housing, the inertial measurement unit being configured to detect changes in orientation of the mobile computing device, and a processor mounted in the housing, the processor being configured to determine an ordered list of application programs including a current application, a next application, and a previous application, display the current application program on the first display, detect a flip motion based on at least a change in orientation of the mobile computing device that is greater than a threshold degree detected via the inertial measurement unit, based on detecting a rightward flip motion from the first display to the second display, display the next application program on the second display, and based on detecting a leftward flip motion from the first display to the second display, display the previous application program on the second display. In this aspect, additionally or alternatively, the processor may be further configured to, for each subsequent rightward flip motion, display corresponding next application programs in the ordered list of application programs. In this aspect, additionally or alternatively, the processor may be further configured to, for each subsequent leftward flip motion, display corresponding previous application programs in the ordered list of application programs.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A mobile computing device comprising:
a housing including a first display and a second display that face away from each other;
an orientation sensor mounted in the housing, the orientation sensor being configured to detect flip motions indicating that the mobile computing device has been flipped in a direction from a first side to a second side; and
a processor mounted in the housing, the processor being configured to:
display a first application program on the first display;
based on detecting a rightward flip motion from the first display to the second display, display a second application program on the second display; and
based on detecting a leftward flip motion from the first display to the second display, display a third application program on the second display.

2. The mobile computing device of claim 1, wherein the orientation sensor is an inertial measurement unit.

3. The mobile computing device of claim 1, wherein the processor is configured to detect flip motions based on at least a change in orientation of the mobile computing device that is greater than a threshold degree detected via the orientation sensor.

4. The mobile computing device of claim 1, wherein the processor is further configured to determine an ordered list of application programs, and wherein the first application program is a current application program in the ordered list of application programs, the second application program is a next application program in the ordered list of application programs, and the third application program is a previous application program in the ordered list of application programs.

5. The mobile computing device of claim 4, wherein the processor is further configured to, for each subsequent rightward flip motion, display corresponding next application programs in the ordered list of application programs.

6. The mobile computing device of claim 4, wherein the processor is further configured to, for each subsequent leftward flip motion, display corresponding previous application programs in the ordered list of application programs.

7. The mobile computing device of claim 1, wherein the processor is further configured to, based on detecting an upward flip motion from the first display to the second display, display a fourth application program on the second display.

8. The mobile computing device of claim 1, wherein the processor is further configured to, based on detecting a downward flip motion from the first display to the second display, display a fifth application program on the second display.

9. The mobile computing device of claim 1, wherein the housing has a first part and a second part coupled by a hinge, the first part including the first display and the second part including the second display, wherein the hinge is configured to permit the first and second displays to rotate between angular orientations from a face-to-face angular orientation to a back-to-back angular orientation, and wherein
the processor is further configured to detect that the first and second displays are in a back-to-back angular orientation.

10. A method comprising:
displaying a first application program on a first display included in a housing of a mobile computing device, the housing further including a second display facing away from the first display, and an orientation sensor configured to detect flip motions indicating that the mobile computing device has been flipped in a direction from a first side to a second side;
based on detecting a rightward flip motion from the first display to the second display, displaying a second application program on the second display; and
based on detecting a leftward flip motion from the first display to the second display, displaying a third application program on the second display.

11. The method of claim 10, further comprising detecting flip motions based on at least a change in orientation of the mobile computing device that is greater than a threshold degree detected via the orientation sensor.

12. The method of claim 11, wherein the threshold degree is 90 degrees.

13. The method of claim 10, further comprising determining an ordered list of application programs, wherein the first application program is a current application program in the ordered list of application programs, the second application program is a next application program in the ordered list of application programs, and the third application program is a previous application program in the ordered list of application programs.

14. The method of claim 13, further comprising, for each subsequent rightward flip motion, displaying corresponding next application programs in the ordered list of application programs.

15. The method of claim 13, further comprising, for each subsequent leftward flip motion, displaying corresponding previous application programs in the ordered list of application programs.

16. The method of claim 10, further comprising, based on detecting an upward flip motion from the first display to the second display, displaying a fourth application program on the second display.

17. The method of claim 10, further comprising, based on detecting a downward flip motion from the first display to the second display, displaying a fifth application program on the second display.

18. A mobile computing device comprising:
a housing including a first display and a second display that face away from each other;
an inertial measurement unit mounted in the housing, the inertial measurement unit being configured to detect changes in orientation of the mobile computing device; and
a processor mounted in the housing, the processor being configured to:
determine an ordered list of application programs including a current application, a next application, and a previous application;
display the current application program on the first display;
detect a flip motion based on at least a change in orientation of the mobile computing device that is greater than a threshold degree detected via the inertial measurement unit;
based on detecting a rightward flip motion from the first display to the second display, display the next application program on the second display; and
based on detecting a leftward flip motion from the first display to the second display, display the previous application program on the second display.

19. The mobile computing device of claim 18, wherein the processor is further configured to, for each subsequent rightward flip motion, display corresponding next application programs in the ordered list of application programs.

20. The mobile computing device of claim 18, wherein the processor is further configured to, for each subsequent leftward flip motion, display corresponding previous application programs in the ordered list of application programs.
